(19) United States
(12) Patent Application Publication
(10) Pub. No.: US 2017/0097186 A1
(43) Pub. Date: Apr. 6, 2017

(54) INNER CASE FOR REFRIGERATOR AND METHOD OF MANUFACTURING THE SAME

(71) Applicant: Samsung Electronics Co., Ltd, Gyeonggi-do (KR)

(72) Inventors: Ho-sang Park, Gwangju (KR); Joon-ho Song, Gwangju (KR)

(21) Appl. No.: 15/286,500

(22) Filed: Oct. 5, 2016

(30) Foreign Application Priority Data
Oct. 5, 2015 (KR) 10-2015-0139661

(51) Int. Cl. F25D 23/06; F25D 23/08; F25D 25/00; B29C 51/10

(52) U.S. Cl. CPC F25D 23/066; B29C 51/10; F25D 23/069; F25D 23/08; F25D 25/005; B29L 2022/007

(57) ABSTRACT

A method of manufacturing an inner case for a refrigerator includes disposing a heated inner case sheet above a mold in a chamber, disposing at least one of screw accommodation member on an external surface of the mold, facing the inner case sheet, curving the inner case sheet to be convex toward an opposite side to the mold, moving the mold toward an internal side of the inner case sheet, and adsorbing the inner case sheet onto the external surface of the mold to form the inner case sheet to correspond to a shape of the mold and insert-molding the screw accommodation member into the inner case sheet.

### CROSS-REFERENCE TO RELATED APPLICATION(S) AND CLAIM OF PRIORITY

This application claims priority from Korean Patent Application No. 10-2015-0139661, filed on Oct. 5, 2015, in the Korean Intellectual Property Office, the disclosure of which is incorporated herein by reference in its entirety.

### TECHNICAL FIELD

Apparatuses and methods consistent with the present disclosure relate to an inner case for a refrigerator and a method of manufacturing the same, and more particularly, to an inner case for a refrigerator including a screw accommodation member and a method of manufacturing the same.

### BACKGROUND

In general, a refrigerator is a device that includes an inner case with a container therein, an external case coupled to the inner case to form an outer appearance of the refrigerator, and a cooling device for supplying chilly air to the inner case to keep foods fresh inside.

It is necessary to separate an internal space of the inner case into a plurality of spaces so as to classify and store various foods according to types. Accordingly, a plurality of partitions for dividing of a space of the inner case and components including the partitions are coupled to an internal portion of the inner case. In general, these components are fixed to the internal portion of the inner case of the refrigerator via screws.

In general, an inner case of a refrigerator is formed of thermoplastics. Accordingly, in order to fix components to an internal portion of the inner case via screws, a separate screw accommodation member for supporting screws and components connected thereto is needed. To this end, conventionally, there was a need for a process of forming an accommodating hole through a completely formed inner case so as to insert a screw accommodation member into the hole, inserting the screw accommodation member into the accommodating hole of the inner case and, then, fixing the screw accommodation member into the accommodating hole via adhesives, or the like. In addition, in order to prevent chilly air inside the inner case from externally leaking through a gap formed between the accommodating hole of the inner case and the screw accommodation member, there was an additional need for a sealing process of sealing the gap between the accommodating hole and the screw accommodation member using wax or the like.

Thereby, according to the conventional technology for coupling and fixing components inside an inner case of a refrigerator inner case, an additional process of coupling a separate screw fixing member to a completely formed inner case and sealing the inner case needs to be performed and, thus, manufacturing cost and time are further consumed. In addition, during a process of forming the accommodating hole through the completely formed inner case, internal components may not be fixed at an accurate position inside a container due to an error in terms of a position for forming the hole. In addition, during the sealing process, the gap between the accommodating hole and the screw accommodation member is not perfectly sealed such that chilly air inside the inner case externally leaks and, thus, a temperature of stored foods is not maintained constant.

### SUMMARY

Exemplary embodiments of the present disclosure overcome the above disadvantages and other disadvantages not described above. Also, the present disclosure is not required to overcome the disadvantages described above, and an exemplary embodiment of the present disclosure may not overcome any of the problems described above.

The present disclosure provides an inner case for a refrigerator and a method of manufacturing the same, which do not require an additional procedure of separately coupling a screw fixation member to the inner case by insert-molding the screw fixation member for coupling components used in the refrigerator into the inner case during molding of the inner case for a refrigerator.

According to an aspect of the present disclosure, a method of manufacturing an inner case for a refrigerator includes disposing a heated inner case sheet above a mold in a chamber, disposing at least one of screw accommodation member on an external surface of the mold, facing the inner case sheet, curving the inner case sheet to be convex toward an opposite side to the mold, moving the mold toward an internal side of the inner case sheet, and adsorbing the inner case sheet onto the external surface of the mold to form the inner case sheet to correspond to a shape of the mold and insert-molding the screw accommodation member into the inner case sheet.

The method may further include, after the adsorbing, separating the mold from the inner case sheet.

The curving may include curving the inner case sheet to be convex upward by a pressure difference between an upper portion and a lower portion of the inner case sheet as air above the inner case sheet inside the chamber is discharged out of the chamber.

The adsorbing may include adsorbing the inner case sheet onto the external surface of the mold by a pressure difference between an upper portion and a lower portion of the inner case sheet as air below the inner case sheet inside the chamber is discharged out of the chamber.

The disposing of the at least one of screw accommodation member may include spacing the screw accommodation member apart from a fixation pin at a location in which a screw coupling groove formed in the screw accommodation member corresponds to the fixation pin protruding from the external surface of the mold, and coupling the screw accommodation member to the fixation pin.

The disposing of the at least one of screw accommodation member may include disposing the screw accommodation member below the mold so as to face a screw accommodation member hole formed through the mold, moving the screw accommodation member through the screw accommodation member hole, and fixing a location of the screw accommodation member while the screw accommodation member protrudes to an external side of the mold.

According to another aspect of the present disclosure, an inner case for a refrigerator includes a body with a contained therein, and a screw accommodation member insert-molded into the body.

The screw accommodation member may be shaped like any one of an inverse circular truncated cone, a cylinder, and a rectangular parallelepiped.

The screw accommodation member may include a screw coupling groove formed therein in a longitudinal direction of the screw accommodation member.

A portion of an outer circumferential surface of one end of the screw accommodation member may be partially cut to form a rotation prevention surface.

The inner case may further include a rotation prevention groove formed on an outer circumferential surface of the screw accommodation member toward an internal side of the screw accommodation member.

The rotation prevention groove may be formed at one end of the screw accommodation member in a longitudinal direction of the screw accommodation member.

The inner case may further include a separation prevention groove formed on an outer circumferential surface of the screw accommodation member toward an internal side of the screw accommodation member, wherein the separation prevention groove may be formed along a circumference of the screw accommodation member.

The separation prevention groove may include a plurality of rotation prevention wings protruding toward an external side of the screw accommodation member.

The screw accommodation member may include a head portion and a body portion including the screw coupling groove, and a width of the head portion may be greater than a width of the body portion and is formed with a step difference with the body portion.

The head portion may include a plurality of rotation preventers protruding outward.

Additional and/or other aspects and advantages of the invention will be set forth in part in the description which follows and, in part, will be obvious from the description, or may be learned by practice of the invention.

### BRIEF DESCRIPTION OF THE DRAWINGS

The above and/or other aspects of the present disclosure will be more apparent by describing certain exemplary embodiments of the present disclosure with reference to the accompanying drawings, in which:

FIG. 1 is a schematic diagram illustrating an internal portion of an inner case for a refrigerator according to an exemplary embodiment of the present disclosure;

FIG. 2 is a schematic diagram illustrating an external portion of the inner case for a refrigerator of FIG. 1;

FIG. 3 is a cross-sectional view illustrating a method of fixing an internal component to be coupled to an internal portion of the inner case for the refrigerator of FIG. 2 via a screw accommodation member and a screw;

FIG. 4 is a schematic flowchart of operations included in a method of manufacturing an inner case for a refrigerator according to an exemplary embodiment of the present disclosure;

FIG. 5 is a cross-sectional view illustrating an operation of disposing a heated inner case sheet above a mold according to an exemplary embodiment of the present disclosure;

FIG. 6 is a cross-sectional view sequentially illustrating an operation of disposing a screw accommodation member on an external surface of a mold;

FIG. 7 is a cross-sectional view sequentially illustrating an operation of disposing a screw accommodation member on an external surface of a mold after the operation illustrated in FIG. 6;

FIG. 8 is a cross-sectional view sequentially illustrating an operation of disposing a screw accommodation member on an external surface of a mold after the operation illustrated in FIG. 7;

FIG. 9 is a cross-sectional view illustrating an operation of curving a heated inner case sheet to be convex toward an opposite side of a mold;

FIG. 10 is a cross-sectional view illustrating an operation of moving a mold toward an internal side of an inner case sheet that is curved to be convex;

FIG. 11 is a cross-sectional view illustrating an operation of adsorbing an inner case sheet onto an external surface of a mold;

FIG. 12 is a cross-sectional view illustrating an operation of separating an inner case sheet from a mold;

FIG. 13 is a schematic diagram illustrating an operation of fixing and separating a screw accommodation member using a transfer arm according to an exemplary embodiment of the present disclosure;

FIG. 14 is a schematic diagram illustrating an operation of disposing a screw accommodation member on an external surface of a mold, according to another embodiment of the present disclosure;

FIG. 15A is a perspective enlarged view of the screw accommodation member illustrated in FIG. 2;

FIG. 15B is a front view of the screw accommodation member illustrated in FIG. 15A;

FIG. 15C is a plan view of the screw accommodation member illustrated in FIG. 15A;

FIG. 15D is a cross-sectional view of the screw accommodation member illustrated in FIG. 15A;

FIG. 16 is a perspective view of a first modified example of a screw accommodation member;

FIG. 17 is a perspective view of a second modified example of a screw accommodation member;

FIG. 18 is a perspective view of a third modified example of a screw accommodation member; and

FIG. 19 is a perspective view of a fourth modified example of a screw accommodation member.

### DETAILED DESCRIPTION

An inner case for a refrigerator according to exemplary embodiments of the present disclosure will now be described in greater detail with reference to the accompanying drawings. The invention may, however, be embodied in many different forms and should not be construed as being limited to the embodiments set forth herein; rather, these embodiments are provided so that this disclosure will fully convey the concept of the invention to those skilled in the art. However, in the following description of the present disclosure, a detailed description of known functions and configurations incorporated herein will be omitted when it may make the subject matter of the present disclosure unclear. In addition, the accompanying drawings are not illustrated with an actual scale and some components such as a screw accommodation member 100 are exaggerated to aid in the understanding of the invention. For example, the screw accommodation member 100 according to an exemplary embodiment of the present disclosure is approximately shaped like an inverse circular truncated cone with an upper side wider than a lower side.

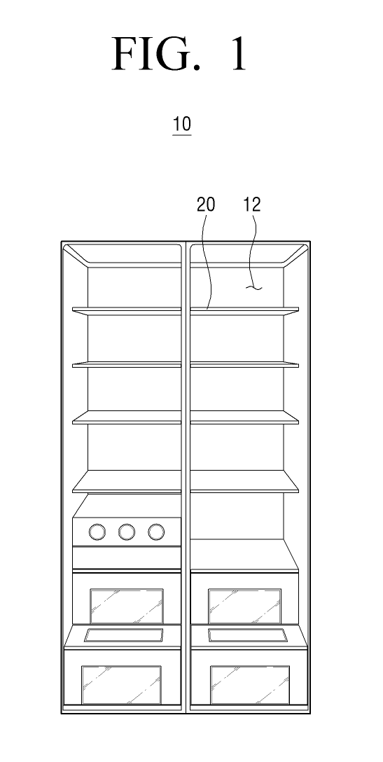

FIG. 1 is a schematic diagram illustrating an internal portion of an inner case 10 for a refrigerator according to an exemplary embodiment of the present disclosure. An internal space of the inner case 10 for the refrigerator may be divided into a plurality of containers 12 through a plurality of partitions and components including the partitions. Accordingly, various foods may be classified and stored in the plurality of containers 12 according to types of the foods. Hereinafter, for convenience of description, a plurality of partitions and components including the partitions will be collectively referred to as an internal component 20.

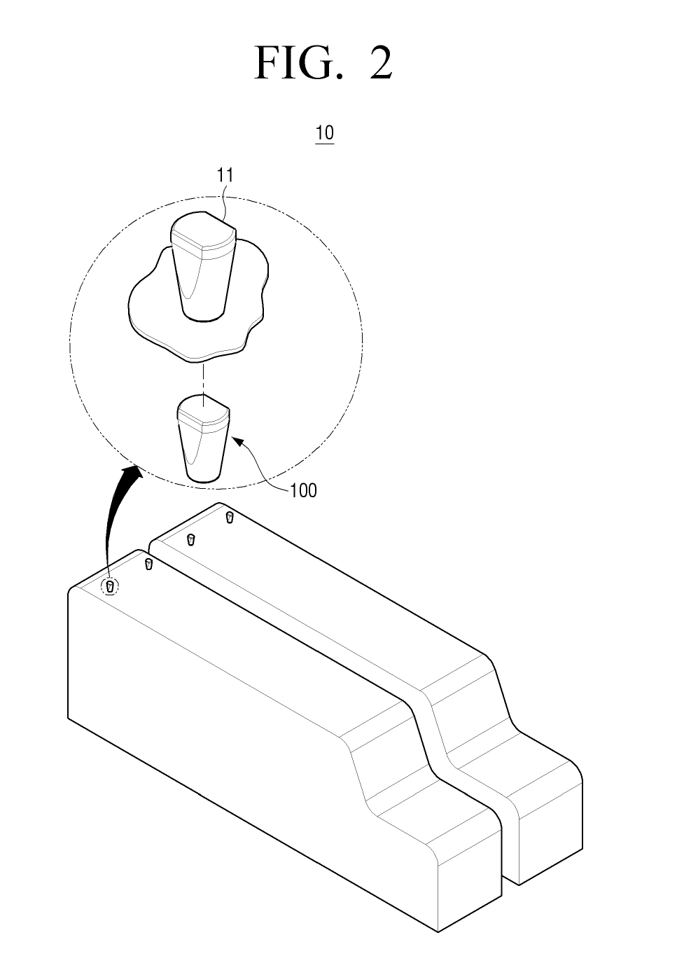

Referring to FIG. 2, the inner case 10 for the refrigerator may include the plurality of screw accommodation members 100 for coupling the internal component 20 that is internally disposed in the inner case 10. The inner case 10 for the refrigerator may include a plurality of protrusions 11 that protrude outside the inner case 10 for the refrigerator so as to correspond to the screw accommodation member 100. The protrusion 11 may include the screw accommodation member 100 so as to surround an external surface except for a lower surface 120 of the screw accommodation member 100.

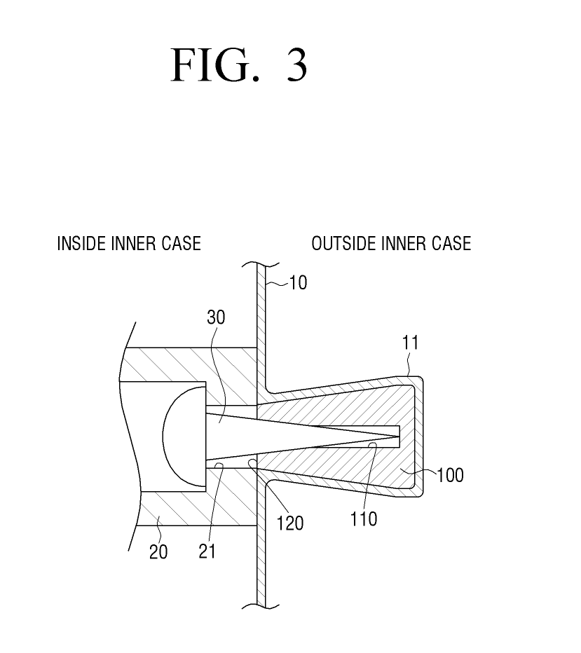

FIG. 3 is a cross-sectional view illustrating a method of fixing the internal component 20 to be coupled to an internal portion of the inner case 10 for the refrigerator via the screw accommodation member 100 and a screw 30.

A connection hole 21 of the internal component 20 may be disposed to contact the lower surface 120 of the screw accommodation member 100 inside the inner case 10 for the refrigerator and, then, the screw 30 may be inserted inside the inner case 10. Accordingly, the screw 30 may be formed through the connection hole 21 of the internal component 20 so as to be inserted into a screw coupling groove 110 in a longitudinal direction of the screw accommodation member 100. Thereby, the internal component 20 may be coupled and fixed to the internal portion of the inner case 10 for the refrigerator.

Accordingly, unlike the prior art, the inner case 10 for the refrigerator according to the present disclosure may not require a separate sealing procedure of filling a gap generated by coupling between the inner case and the screw accommodation member as well as a procedure of separately coupling a screw accommodation member to an inner case in order to couple the internal component to the inner case for a refrigerator. Accordingly, the inner case 10 for the refrigerator according to the present disclosure may be advantageous in that a procedure of connecting the internal component 20 inside the inner case 10 is simplified.

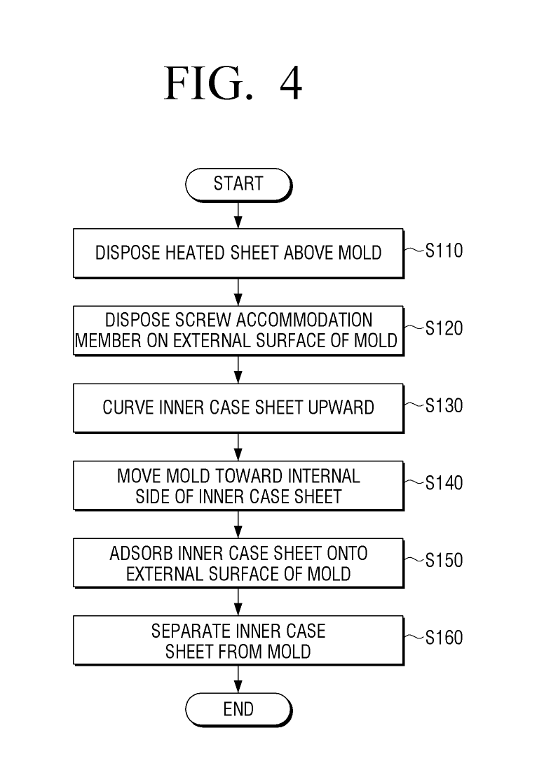

FIG. 4 is a schematic flowchart of operations included in a method of manufacturing the inner case 10 for the refrigerator according to an exemplary embodiment of the present disclosure.

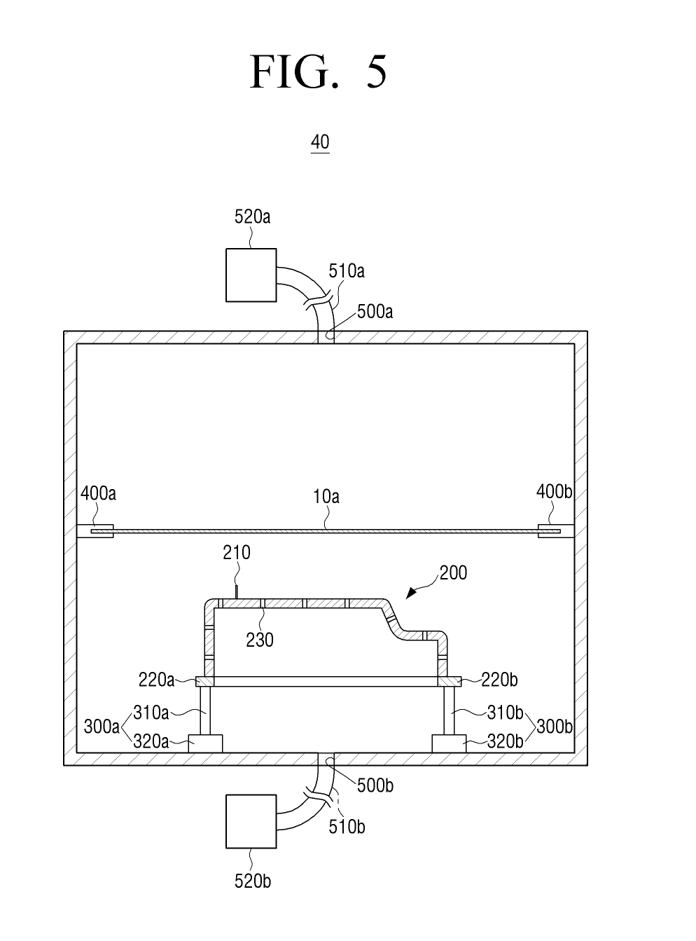

FIGS. 5 to 12 illustrate an operation of shaping a heated inner case sheet 10a into the inner case 10 for the refrigerator in a chamber 40. For convenience of description, a cross-sectional view of some components is illustrated.

Prior to a description of the method of manufacturing the inner case 10 for the refrigerator according to the present disclosure, the chamber 40 as a space for manufacturing the inner case 10 for the refrigerator will be described with reference to FIG. 5. The inner case 10 for the refrigerator may be manufactured in the chamber 40. A mold 200 may be disposed in the chamber 40. The mold 200 may have a shape corresponding to a shape of the inner case 10 for the refrigerator and have a hollow structure. A plurality of fixation pins 210 may be formed to protrude on an external surface of the mold 200 in order to allow the screw coupling groove 110 of the screw accommodation member 100 to be coupled to the fixation pins 210. In addition, a plurality of air holes 230 may be formed in the mold 200. Structures and functions of the fixation pin 210 and the air hole 230 of the mold 200 will be described in detail with regard to the method of manufacturing the inner case 10 for the refrigerator which will be described below.

An elevating portion 300 for elevating the mold 200 may be connected to a lower portion 220 of the mold 200. The elevating portion 300 may include a first elevating portion 300a for supporting a first end 220a of the lower portion 220 of the mold 200 and a second elevating portion 300b for supporting a second end 220b of the lower portion 220 of the mold 200. The first and second elevating portions 300a and 300b may include respective first and second elevating axes 310a and 310b and respective first and second elevating drivers 320a and 320b.

The first and second elevating axes 310a and 310b may be connected to the first end 220a and the second end 220b of the lower portion 220 of the mold 200, respectively and opposite portions to the portions of first and second elevating axes 310a and 310b, which are connected to the mold 200, may be connected to the first and second elevating drivers 320a and 320b, respectively. In addition, the first and second elevating axes 310a and 310b may each include a plurality of cylinders (not shown) and a plurality of pistons (not shown). Accordingly, the first and second elevating axes 310a and 310b may be extended or shortened in a longitudinal direction. The first and second elevating drivers 320a and 320b may be disposed at a lower portion in the chamber 40, and power is supplied to the first and second elevating axes 310a and 310b to extend or shorten the first and second elevating axes 310a and 310b. Accordingly, the mold 200 connected to the first and second elevating axes 310a and 310b may be elevated by the elevating portion 300.

Unlike in FIG. 5, one elevating portion 300 instead of two elevating portions 300 may be configured and two or more elevating portions 300 may be configured. In addition, the elevating portion 300 may also be disposed at a lateral surface and an upper portion of the chamber 40 as long as the mold 200 is elevated. In addition, the elevating portion 300 may be a hydrodynamic lift or a pneumatic lift.

The chamber 40 may include an air vent 500 for discharging air out of the chamber 40 from an internal portion of the chamber 40. The air vent 500 may include an upper air vent 500a and a lower air vent 500b that are disposed at upper and lower ends of the chamber 40. Although FIG. 5 illustrates the case in which only one upper air vent 500a and one lower air vent 500b are installed in the chamber 40, the number thereof may be increased. The upper and lower air vents 500a and 500b may be connected to upper and lower air exhaust pumps 520a and 520b through upper and lower air exhaust pipes 510a and 510b, respectively. Accordingly, according to drive of the upper and lower air exhaust pumps 520a and 520b, air inside the chamber 40 may be discharged out of the chamber 40 through the upper and lower air exhaust pipes 510a and 510b, respectively. In addition, the upper and lower air exhaust pumps 520a and 520b may be integrated together such that the upper and lower air exhaust pipes 510a and 510b are connected to one air exhaust pump. An operation and function of the air vent 500 will be described in detail with regard to the method of manufacturing the inner case 10 for the refrigerator which will be described below.

Hereinafter, with reference to FIGS. 5 to 12, a method of manufacturing the inner case 10 for the refrigerator according to an exemplary embodiment of the present disclosure will be described.

Referring to FIG. 5, as a first operation for manufacturing the inner case 10 for the refrigerator, the heated inner case sheet 10a may be disposed on the mold 200 in the chamber 40 (S110). The inner case sheet 10a may be shaped into the inner case 10 for the refrigerator via a molding procedure using the mold 200. The inner case sheet 10a may be formed of a thermoplastic resin such as thermoplastics. Accordingly, the inner case sheet 10a may be heated such that the inner case sheet 10a is flexible so as to be modified.

The inner case sheet 10a may be fixed by a fixation portion 400. The fixation portion 400 may include first and second fixation portions 400a and 400b. The first fixation portion 400a may fix one end of the inner case sheet 10a and the second fixation portion 400b may fix the other end of the inner case sheet 10a so as to fix the opposite ends of the inner case sheet 10a. The heated inner case sheet 10a may be disposed above the mold 200 as the fixation portion 400 is moved inside the chamber 40 while being fixed by the fixation portion 400. In addition, a non-heated inner case sheet 10a may be heated by a separate heat source (not shown) in the chamber 40 after the inner case sheet 10a is disposed in the chamber 40 while being fixed by the fixation portion 400. A position of the fixation portion 400 for fixing the inner case sheet 10a may also be fixed in the chamber 40 as long as the inner case sheet 10a is disposed in the chamber 40.

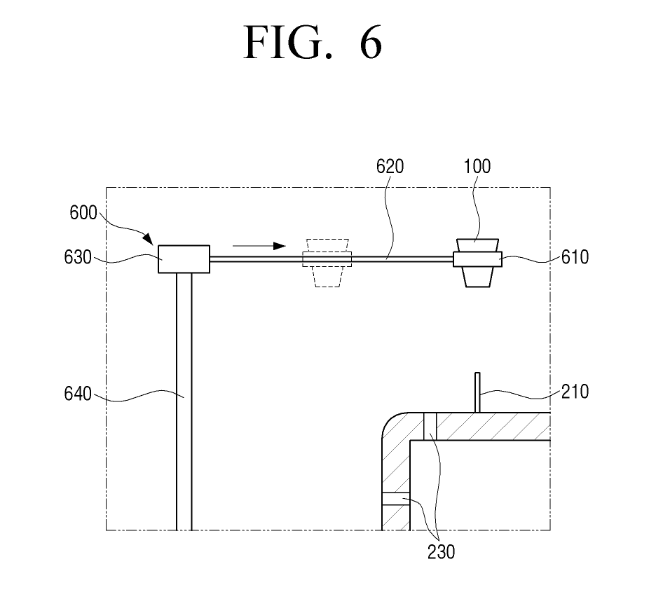

Referring to FIGS. 6 to 9, after the inner case sheet 10a is disposed above the mold 200 in the chamber 40, the screw accommodation member 100 may be disposed on the external surface of the mold 200 (S120).

As described above, the plurality of fixation pins 210 may be formed to protrude on the external surface of the mold 200 in an outer direction of the mold 200. The fixation pin 210 may be inserted into the screw coupling groove 110 that is formed in a longitudinal direction of the screw accommodation member 100. Accordingly, a length of the fixation pin 210 needs to be smaller than that of the screw coupling groove 110 and a thickness of the fixation pin 210 needs to be smaller than that of the screw coupling groove 110.

FIG. 6 is an enlarged view of an operation of disposing the screw accommodation member 100 above the fixation pin 210 formed on the external surface of the mold 200 in the chamber 40. According to an exemplary embodiment of the present disclosure, the screw accommodation member 100 may be transferred by the transfer portion 600 and disposed at the fixation pin 210.

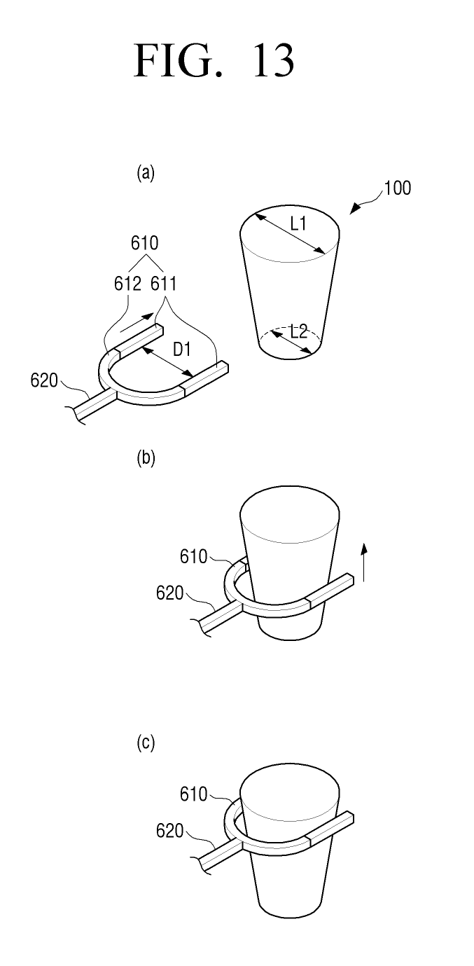

A configuration of the transfer portion 600 for transferring the screw accommodation member 100 according to an exemplary embodiment of the present disclosure is now be described. The transfer portion 600 may include a transfer arm 610, a horizontal axis 620, a first transfer driver 630, a vertical axis 640, and a second transfer driver (not shown). The transfer arm 610 may be a structure for fixing and separating the screw accommodation member 100, and the structure of the transfer arm 610 for fixing and separating the screw accommodation member 100 will be described below with reference to FIG. 13.

As illustrated in FIG. 6, the transfer arm 610 may be coupled to one end of the horizontal axis 620. The horizontal axis 620 may be shaped like a bar that horizontally extend with respect to the ground and may include a plurality of pistons (not shown) and a plurality of cylinders (not shown). Accordingly, the horizontal axis 620 may be extended and shortened in a longitudinal direction, and the transfer arm 610 connected to the horizontal axis 620 may be moved in a horizontal direction by extending and shortening the horizontal axis 620. In addition, the first transfer driver 630 may be connected to the other end opposite to the end connected to the transfer arm 610 of the horizontal axis 620. The first transfer driver 630 may supply power to the horizontal axis 620 and, accordingly, the horizontal axis 620 may be extended and shortened in a horizontal direction.

In addition, the first transfer driver 630 may also be connected to the vertical axis 640 perpendicular to the horizontal axis 620. The vertical axis 640 may also be shaped like a bar that extends in a longitudinal direction and may include a plurality of pistons (not shown) and a plurality of cylinders (not shown). Accordingly, the vertical axis 640 may be extended and shortened in a longitudinal direction. The second transfer driver may be connected to the other end opposite to the end connected to the first transfer driver 630 of the vertical axis 640. The second transfer driver may supply power to the vertical axis 640 and, accordingly, the vertical axis 640 may be extended and shortened in a longitudinal direction. That is, the vertical axis 640 may be extended and shortened up and down by the second transfer driver. By extending and shortening the vertical axis 640, the first transfer driver 630 connected to the vertical axis 640 may be raised or lowered. Accordingly, the horizontal axis 620 and the transfer arm 610 connected to the first transfer driver 630 may also be raised or lowered.

As a result, the transfer arm 610 may be moved up, down, right, and left with respect to a bottom surface of the chamber 40 using the horizontal axis 620, the first transfer driver 630, the vertical axis 640, and second transfer driver. Accordingly, the screw accommodation member 100 fixed to the transfer arm 610 may also be transferred up, down, right, and left. The transfer portion 600 according to an exemplary embodiment of the present disclosure may include the transfer arm 610, the horizontal axis 620, the first transfer driver 630, the vertical axis 640, and second transfer driver but this is merely exemplary and, thus, the transfer portion 600 may include any component for transferring the screw accommodation member 100. In addition, although one transfer arm 610 transfers one screw accommodation member 100 according to the present disclosure, the plurality of screw accommodation member 100 may be transferred at one time and disposed on the external surface of the mold 200.

Hereinafter, operation S120 of disposing the screw accommodation member 100 on the external surface of the mold 200 will be described. Referring to FIG. 6, the transfer portion 600 including the transfer arm 610 to which the screw accommodation member 100 is fixed may be disposed in the chamber 40. In this case, the transfer arm 610 to which the screw accommodation member 100 is fixed may be disposed higher than an upper end of the fixation pin 210. Then the horizontal axis 620 may extend in a horizontal direction toward the fixation pin 210 of the mold 200 by the first transfer driver 630. Accordingly, the transfer arm 610 and the screw accommodation member 100 fixed to the transfer arm 610 may also be moved in a horizontal direction toward the fixation pin 210. The horizontal axis 620 may extend up to a predetermined location such that the screw coupling groove 110 of the screw accommodation member 100 fixed to the transfer arm 610 corresponds to the fixation pin 210. Accordingly, the screw accommodation member 100 may be disposed above the fixation pin 210 protruding on the external surface of the mold 200. That is, the screw coupling groove 110 and the fixation pin 210 of the screw accommodation member 100 may be spaced apart from each other at corresponding locations.

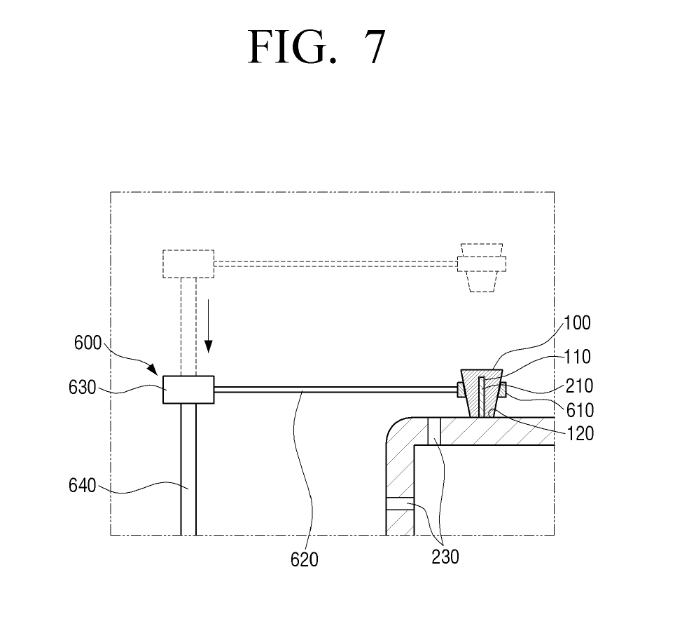

Referring to FIG. 7, the screw accommodation member 100 that is spaced apart from and disposed on the fixation pin 210 so as to correspond to the fixation pin 210 may be coupled to the fixation pin 210 by lowering the transfer arm 610. As described above, the vertical axis 640 may be extended or shortened by the second transfer driver, and the first transfer driver 630, the horizontal axis 620, and the transfer arm 610 that are connected to the vertical axis 640 may be lowered by shortening the vertical axis 640. Accordingly, the screw accommodation member 100 may be disposed on the external surface of the mold 200 while the screw coupling groove 110 is coupled to the fixation pin 210.

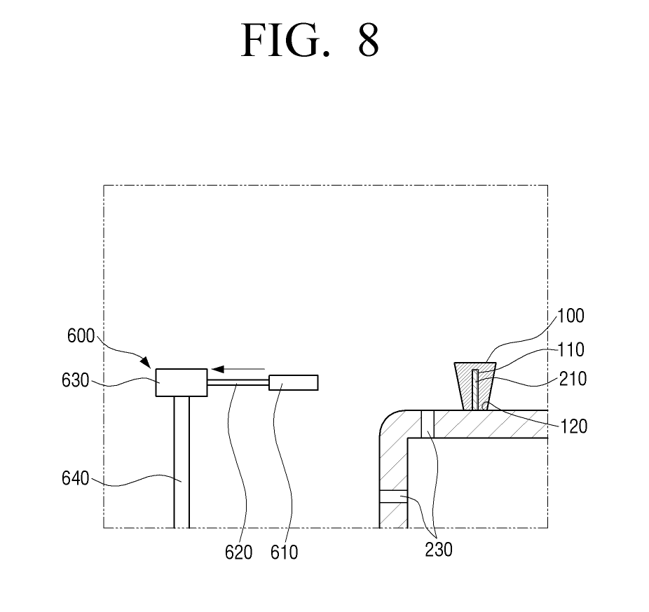

Referring to FIG. 8, when the screw accommodation member 100 is disposed on the external surface of the mold 200 by lowering the vertical axis 640, the transfer arm 610 for fixing the screw accommodation member 100 may separate the screw accommodation member 100. The transfer arm 610 for separating the screw accommodation member 100 is deviated from an upper portion of the mold 200 by re-shortening the horizontal axis 620 that extends toward the mold 200. In addition, the transfer portion 600 may be disposed at a lower location than the upper portion of the mold 200 by additionally lowering the vertical axis 640 in order to prevent the transfer portion 600 from interfering with a molding procedure of the inner case sheet 10a.

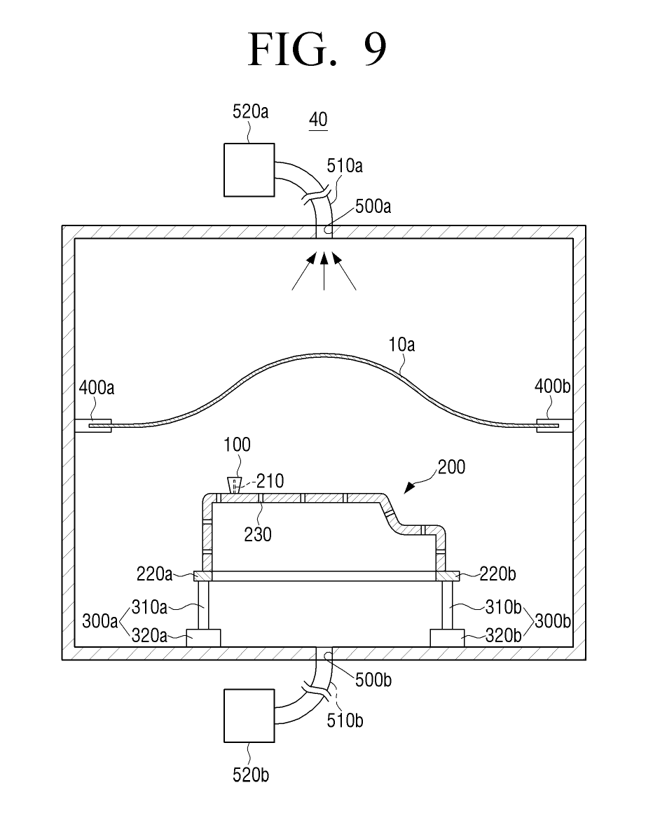

Referring to FIG. 9, the screw accommodation member 100 may be disposed on the external surface of the mold 200 and then the heated inner case sheet 10a may be curved in an opposite direction to the mold 200 (S130). The upper air vent 500a may be disposed at an upper portion of the chamber 40 and, simultaneously, disposed above the inner case sheet 10a. In addition, a plurality of upper air vent 500a may be used. The upper air vent 500a may rapidly discharge air above the inner case sheet 10a in the chamber 40 out of the chamber 40 via an operation of the upper air exhaust pump 520a. Accordingly, according to the air flow, a pressure above the inner case sheet 10a in the chamber 40 may be lower than a pressure below the inner case sheet 10a. In addition, the upper portion of the inner case sheet 10a may be instantaneously in a vacuum. Due to the pressure difference, the inner case sheet 10a may be curved to be convex upward.

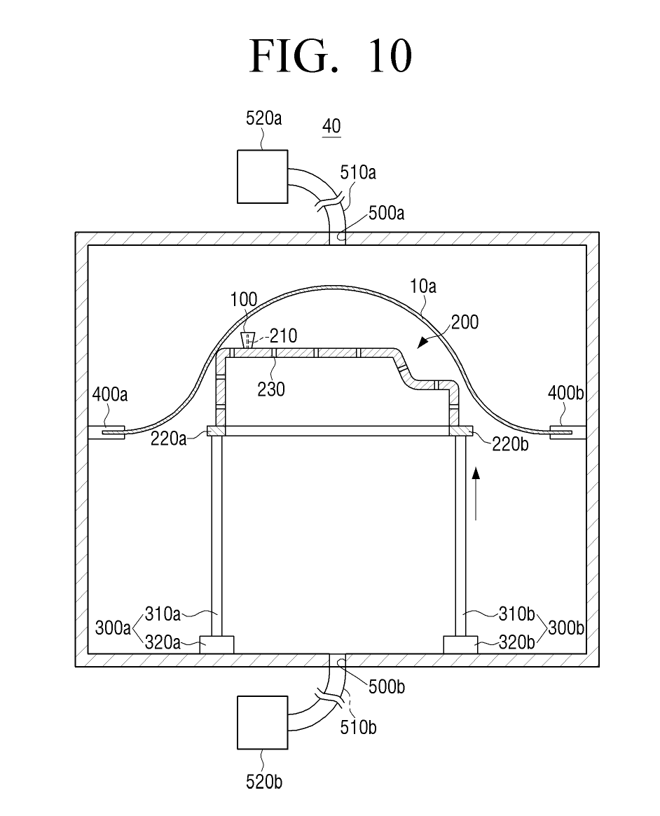

Referring to FIG. 10, the mold 200 dispose below the inner case sheet 10a may be moved toward an internal part of the inner case sheet 10a that is curved to be convex upward (S140). As described above, the mold 200 may be raised and lowered by the elevating portion 300. Accordingly, as the mold 200 is raised by the elevating portion 300, the mold 200 may be disposed in the internal part of the inner case sheet 10a that is curved to be convex upward.

According to an exemplary embodiment of the present disclosure, the first and second elevating axes 310a and 310b connected to the first and second ends 220a and 220b of the lower portion 220 of the mold 200 may be raised by the first and second elevating drivers 320a and 320b, respectively. Accordingly, the mold 200 may be moved to the internal part of the curved inner case sheet 10a. In addition, a portion of the mold 200 moved to the internal part of the curved inner case sheet 10a may come in contact with a lower portion of the inner case sheet 10a. Unlike in an exemplary embodiment of the present disclosure, a location of a mold in a chamber may be fixed and the inner case sheet 10a fixed to a fixation portion may be moved toward an external surface of a mold.

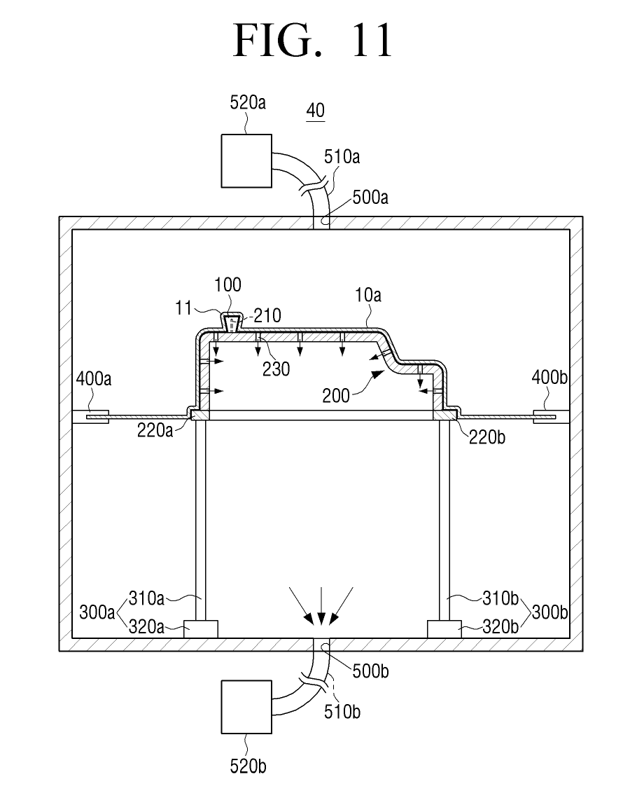

Referring to FIG. 11, after the mold 200 is moved to the internal part of the inner case sheet 10a that is curved to be convex upward, the inner case sheet 10a may be adsorbed onto the external surface of the mold 200 (S150). The lower air vent 500b may be disposed at a lower end of the chamber 40 and disposed below the inner case sheet 10a. In addition, a plurality of lower air vents 500b may be used. The lower air vent 500b may rapidly discharge air below the inner case sheet 10a in the chamber 40 out of the chamber 40 through the lower air exhaust pipe 510b via an operation of the lower air exhaust pump 520b. The plurality of air holes 230 may be formed in the mold 200. Accordingly, air between the external surface of the mold 200 and the inner case sheet 10a may be passed through the air hole 230. Thus, as air below the inner case sheet 10a is discharged out of the chamber 40 through the lower air vent 500b, air between the external surface of the mold 200 and the inner case sheet 10a may also be discharged through the lower air vent 500b through an internal portion of the mold 200 through the air hole 230. According to the air flow, a pressure below the inner case sheet 10a in the chamber 40 may be lower than a pressure above the inner case sheet 10a. In addition, the lower portion of the inner case sheet 10a in the chamber 40 may be instantaneously in a vacuum. Accordingly, the inner case sheet 10a may be adsorbed onto the external surface of the mold 200.

When the inner case sheet 10a is adsorbed onto the external surface of the mold 200, the inner case sheet 10a may be formed with the same shape as that of the mold 200. Since the screw accommodation member 100 is disposed on the external surface of the mold 200, the inner case sheet 10a may also be adsorbed onto the screw accommodation member 100. Accordingly, the protrusion 11 may be formed on the inner case sheet 10a so as to correspond to a shape of the screw accommodation member 100. That is, as the inner case sheet 10a is adsorbed onto the external surface of the mold 200, the inner case sheet 10a may be formed to correspond to the shape of the mold 200 in which the screw accommodation member 100 is disposed.

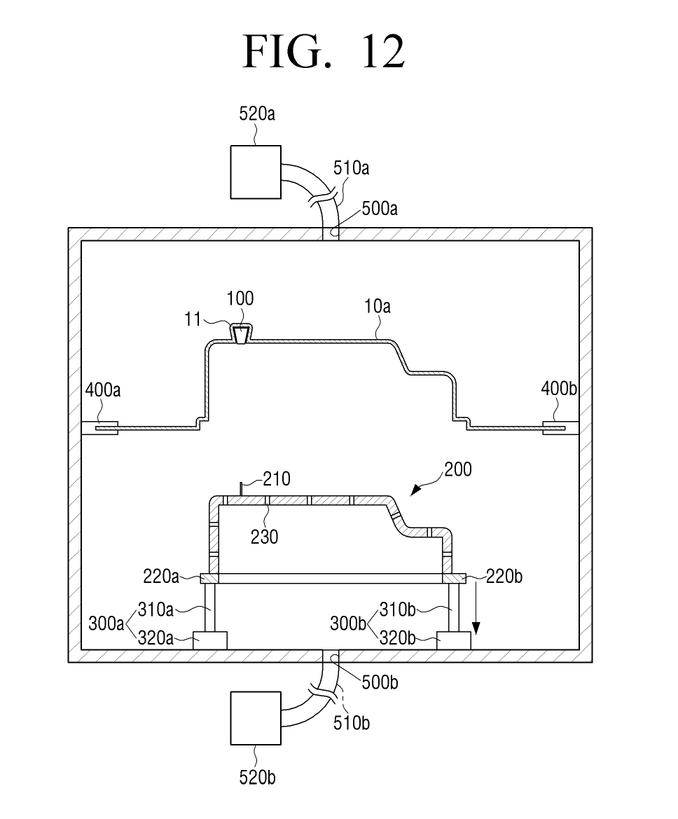

Referring to FIG. 12, as the inner case sheet 10a is adsorbed onto the external surface of the mold 200, the inner case sheet 10a may be formed to correspond to the shape of the mold 200 in which the screw accommodation member 100 is disposed and, then, the mold 200 may be re-lowered through the elevating portion 300. As the mold 200 is lowered, the inner case sheet 10a and the mold 200 may be separated from each other (S160). After the inner case sheet 10a is heated, a temperature may be continuously lowered according to a flow of the manufacturing operations (S110 to S150). Accordingly, as the inner case sheet 10a that is formed to correspond to the shape of the mold 200 loses plasticity as a temperature is lowered, the inner case sheet 10a may be hardened with a shape corresponding to the shape of the mold 200. Accordingly, even if the mold 200 is separated from the inner case sheet 10a, the shape of the inner case sheet 10a formed to correspond to the shape of the mold 200 may be maintained. After the inner case sheet 10a is adsorbed onto the external surface of the mold 200, the method may further include an operation of lowering a temperature so as to harden the shape of the inner case sheet 10a.

As the mold 200 is separated from the completely formed inner case sheet 10a, the fixation pin 210 is separated from the screw coupling groove 110 of the screw accommodation member 100 and the screw accommodation member 100 may also be separated from the mold 200 while being coupled to the inner case sheet 10a. As described above, as the inner case sheet 10a is adsorbed onto the external surface of the mold 200, the inner case sheet 10a may also be adsorbed onto the external surface of the screw accommodation member 100. Accordingly, the protrusion 11 corresponding to the shape of the screw accommodation member 100 may be hardened while being absorbed onto the external surface of the screw accommodation member 100. As the shape of the protrusion 11 of the inner case sheet 10a, which was flexible, may be hardened via heating, the protrusion 11 may be hardened to surround an internal portion of the screw accommodation member 100.

Thereby, since the screw accommodation member 100 is disposed on the external surface of the mold 200, a procedure of integrating the screw accommodation member 100 with the inner case sheet 10a during forming of the inner case sheet 10a using the mold 200 may be defined as a procedure of insert-molding the screw accommodation member 100 into the inner case sheet 10a.

The screw accommodation member 100 is shaped like an inverse circular truncated cone and, thus, the protrusion 11 formed to correspond to the shape of the screw accommodation member 100 may also be shaped like an inverse circular truncated cone. Accordingly, even if the mold 200 is lowered, the screw accommodation member 100 included in the protrusion 11 shaped like an inverse circular truncated cone may be fixed to a tapered lateral surface of the protrusion 11 surrounding the external surface of the screw accommodation member 100. Accordingly, even if the mold 200 is lowered, the screw accommodation member 100 may be prevented from being separated from the protrusion 11 and the fixation pin 210 may be separated from the screw coupling groove 110 of the screw accommodation member 100.

The inner case sheet 10a on which the screw accommodation member 100 is insert-molded may be completely formed as being separated from the mold 200 and only a required portion may be cut from the fixation portion 400 to completely form the inner case 10 for the refrigerator.

FIG. 13 is a schematic diagram illustrating structures of the transfer arm 610 and the screw accommodation member 100 and an operation of fixing and separating the screw accommodation member 100 using the transfer arm 610, according to an exemplary embodiment of the present disclosure. The transfer arm 610 may be connected to the horizontal axis 620. The transfer arm 610 may include a pair of contact portions 611 and a connection portion 612 for connection between the contact portions 611. The contact portions 611 may each be shaped like a straight bar and the pair of contact portions 611 may be spaced apart in parallel to each other by a first distance D1. Ends of the contact portions 611 spaced apart by the first distance D1 may be connected through the connection portion 612 and the other end of the transfer arm 610, which is not connected to the connection portion 612, may be opened. As described above, the screw accommodation member 100 may be shaped like a circular truncated cone. In addition, a width L1 of an upper surface of the screw accommodation member 100 may be greater than a width L2 of a lower surface. In addition, the first distance D1 may be smaller than the width L1 of the upper surface of the screw accommodation member 100 and greater than the width L2 of the lower surface.

In order to transfer the screw accommodation member 100 using the transfer arm 610, the screw accommodation member 100 may be fixed and separated as follows.

Referring to (a) of FIG. 13, the opened portions of the pair of contact portions 611 may approach toward the lower portion of the screw accommodation member 100 in a horizontal direction. In this case, a width of the lower portion of the screw accommodation member 100 needs to be smaller than the first distance D1.

Referring to (b) of FIG. 13, the transfer arm 610 that approaches the screw accommodation member 100 in a horizontal direction may allow the screw accommodation member 100 to be disposed between the pair of contact portions 611.

Referring to (c) of FIG. 13, after the screw accommodation member 100 is disposed between the pair of contact portions 611, the transfer arm 610 may be raised in a longitudinal direction of the screw accommodation member 100. As the transfer arm 610 is raised, the pair of contact portions 611 may come in contact with the lateral surface of the screw accommodation member 100 at a predetermined location in which a width of the screw accommodation member 100 is the same as the first distance D1. Accordingly, the screw accommodation member 100 may interfere with the pair of contact portions 611 to be fixed to the transfer arm 610. In addition, the screw accommodation member 100 may also interfere with the connection portion 612 to be fixed to the transfer arm 610. Accordingly, the screw accommodation member 100 may be raised by the transfer arm 610.

The connection portion 612 may be shaped like a straight bar or shaped like a curved shape corresponding to the lateral surface of the screw accommodation member 100. Thereby, a contact surface between the connection portion 612 and the screw accommodation member 100 may be raised so as to the screw accommodation member 100 may be tightly fixed while being transferred.

The operation of separating the screw accommodation member 100 fixed to the transfer arm 610 from the transfer arm 610 may be inversely performed to the aforementioned fixing operation such that the screw accommodation member 100 is disposed at a desired location of the external surface of the mold 200 and then the transfer arm 610 extends in a longitudinal direction of the screw accommodation member 100. Accordingly, from a time point in which a width of the screw accommodation member 100 becomes smaller than the first distance D1, the transfer arm 610 may be separated from the screw accommodation member 100 in a horizontal direction.

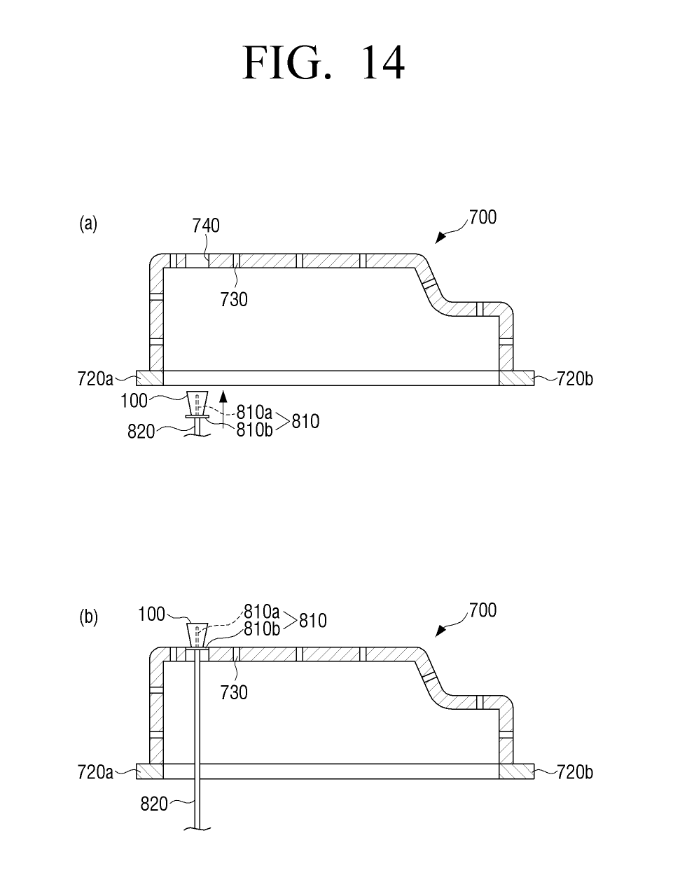

FIG. 14 is a schematic diagram illustrating operation S120′ of disposing the screw accommodation member 100 on an external surface of a mold 700, according to another embodiment of the present disclosure. Hereinafter, the operation of disposing the screw accommodation member 100 on the external surface of the mold 700 will be described in terms of a difference from an embodiment of the present disclosure.

The mold 700 according to another embodiment of the present disclosure may include a screw accommodation member hole 740 through which the screw accommodation member 100 is positioned. The screw accommodation member hole 740 may be formed on the external surface of the mold 700 in which the screw accommodation member 100 is disposed. FIG. 14 illustrates the case in which the screw accommodation member hole 740 is formed above the mold 700 and, thus, the operation of disposing the screw accommodation member 100 on the external surface of the mold 700 will be described in terms of the case as an example.

Referring to (a) of FIG. 14, a transfer portion 800 for transferring the screw accommodation member 100 to the external surface of the mold 700 may be disposed in a lower portion of the mold 700. The transfer portion 800 may transfer the screw accommodation member 100 so as to allow the screw accommodation member 100 to be transferred through the screw accommodation member hole 740. As the transfer portion 800 is stopped at a time point in which the screw accommodation member 100 is transferred through the screw accommodation member hole 740 and protrudes out of the mold 700, a location of the screw accommodation member 100 may be fixed to the external surface of the mold 700.

The transfer portion 800 may include a transfer plate 810, a transfer axis 820, and a transfer driver (not shown). The transfer plate 810 may include a transfer fixation pin 810a and a support 810b. The transfer fixation pin 810a may be disposed at an intermediate portion of an upper portion of the support 810b and may protrude upward. In addition, a length of the transfer fixation pin 810a may be smaller than a length of the screw coupling groove 110 and a length of the transfer fixation pin 810a is smaller than a thickness of the screw coupling groove 110 so as to allow the transfer fixation pin 810a to be inserted into the screw coupling groove 110. The support 810b may be wider than the lower surface 120 so as to support the lower surface 120 of the screw accommodation member 100. The transfer axis 820 may be connected to the lower portion of the transfer plate 810. The transfer axis 820 may be shaped like a bar that extends in a longitudinal direction and may include a plurality of pistons (not shown) and a plurality of cylinders (not shown). Accordingly, the transfer axis 820 may be extended and shortened in a longitudinal direction. Accordingly, as the transfer axis 820 is extended and shortened, a location of the transfer plate 810 may be changed.

As the screw coupling groove 110 of the screw accommodation member 100 is coupled to the transfer fixation pin 810a, the lower surface 120 of the screw accommodation member 100 may come in contact with the upper surface of the support 810b. Thus, the screw accommodation member 100 may be fixed to the transfer plate 810.

Then the transfer portion 800 may be disposed such that the screw accommodation member 100 corresponds to the screw accommodation member hole 740 below the mold 700. Referring to (b) of FIG. 14, as the transfer axis 820 extends upward by a transfer driver, the transfer plate 810 may be raised and the screw accommodation member 100 may also be raised. Thus, the screw accommodation member 100 may be transferred through the screw accommodation member hole 740 through the internal portion of the mold 700. When the screw accommodation member 100 is transferred through the screw accommodation member hole 740 and disposed on the external surface of the mold 700, an operation of the transfer driver may be stopped and a location of the transfer plate 810 may be fixed. Accordingly, the screw accommodation member 100 may be disposed while being fixed to the transfer plate 810 on the external surface of the mold 700.

Unlike in FIG. 14, the screw accommodation member hole 740 may be formed on the upper surface of the mold 700 and may also be formed at a different location such as a lateral surface of the mold 700. In this case, a transfer axis may extend in a horizontal direction and a transfer plate connected to the transfer axis may be moved right and left. The transfer portion 800 of FIG. 14 is exemplary and, thus, any different structures and components may be used as long as the screw accommodation member 100 is transferred to the external surface of the mold 700 through an internal portion of the mold 700. In addition, a plurality of transfer portions 800 may be used, and the screw accommodation member 100 may be fed from the lower portion or the internal portion of the mold 700.

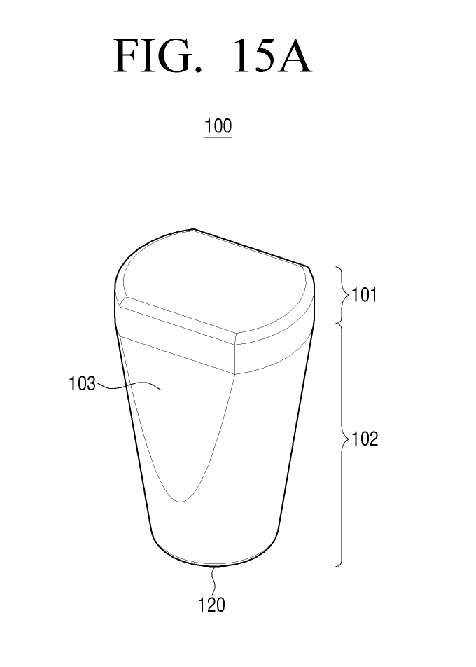

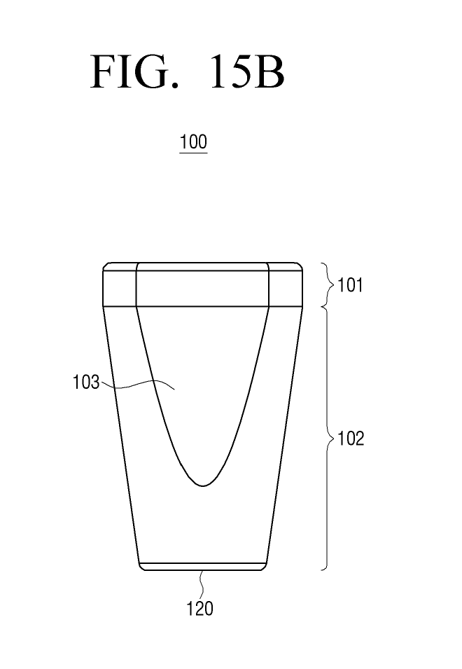

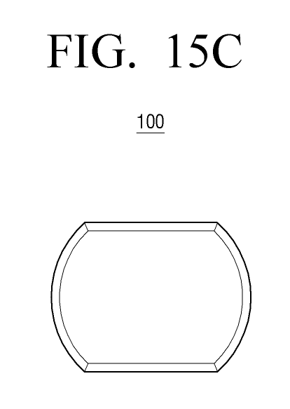

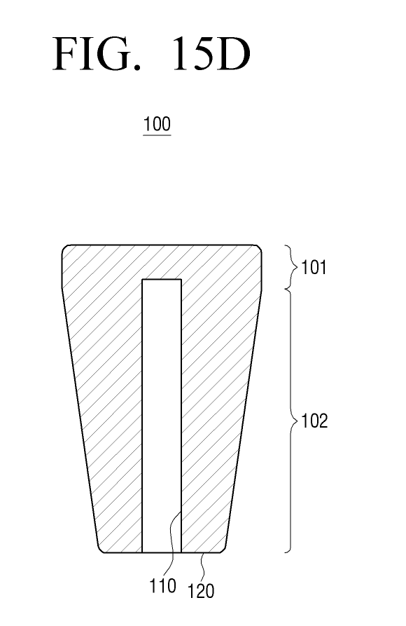

Hereinafter, with reference to FIGS. 15 to 19, a structure of the screw accommodation member 100 according to the embodiment of the present disclosure and modified examples thereof will be described.

FIGS. 15A to 15D are a perspective view, a lateral view, and a cross-sectional view of the screw accommodation member 100 according to the embodiment of the present disclosure. As described above, the screw accommodation member 100 may be shaped like an inverse circular truncated cone. Accordingly, a cross section of the screw accommodation member 100 may taper toward a lower end from an upper end. Accordingly, the screw accommodation member 100 may be prevented from being separated from an internal portion of the protrusion 11 of the insert-molded inner case 10. The screw accommodation member may be shaped like other stereoscopic structure such as a cylindrical shape or a rectangular parallelepiped shape. In addition, the screw accommodation member 100 may include a head portion 101 and a body portion 102. The head portion 101 may correspond to an upper portion of the screw accommodation member 100, an upper surface of which protrudes, and may have a constant cross section unlike the tapered body portion 102.

As illustrated in FIGS. 15A to 15C, a portion of an outer circumferential surface of the screw accommodation member 100 may be cut to form a rotation prevention surface 103. When the screw accommodation member 100 is insert-molded into the inner case sheet 10a, the protrusion 11 may be shaped to correspond to the shape of the screw accommodation member 100. Accordingly, a surface corresponding to the rotation prevention surface 103 is formed on the protrusion 11 and, thus, the rotation prevention surface 103 may interfere with the surface corresponding to the protrusion 11. Thereby, even if the screw 30 is coupled to the screw accommodation member 100, the screw accommodation member 100 may be prevented from being rotated in the protrusion 11 by rotating force of the screw 30.

Referring to FIG. 15D, as described above, the screw coupling groove 110 that is formed through a lower end of the screw accommodation member 100 toward an upper end in a longitudinal direction may be formed in the screw accommodation member 100. The screw coupling groove 110 may be formed through the body portion 102. In addition, the screw coupling groove 110 may be formed through the body portion 102 from the head portion 101. That is, the screw coupling groove 110 may be formed through the screw accommodation member 100 in a longitudinal direction.

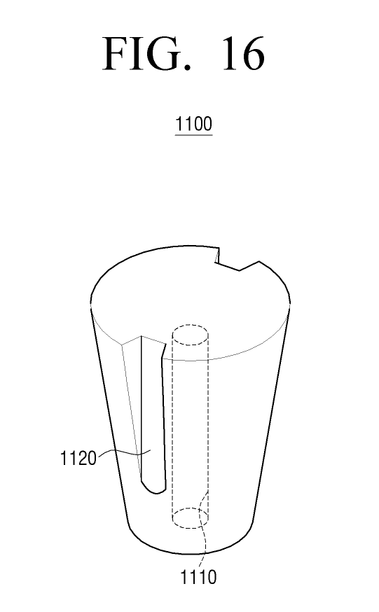

FIG. 16 is a perspective view of a first modified example of a screw accommodation member. A screw accommodation member 1100 according to the first modified example may be shaped like an inverse circular truncated cone and may include a screw coupling groove 1110 formed through the screw accommodation member 1100 toward an upper end from a lower end in a longitudinal direction. The screw accommodation member 1100 may further include a rotation prevention groove 1120 that is formed on a lateral surface of the screw accommodation member 1100 towards an internal side of the screw accommodation member 1100. The rotation prevention groove 1120 may be formed in a longitudinal direction of the screw accommodation member 1100. The rotation prevention groove 1120 may be formed toward a lower end of the screw accommodation member 1100 from an upper surface. Accordingly, during insert-molding of the screw accommodation member 1100 into the inner case sheet 10a, the protrusion 11 may be formed to correspond to a shape of the rotation prevention groove 1120. Thus, the rotation prevention groove 1120 may interfere with the protrusion 11, thereby preventing the screw accommodation member 1100 from being rotated.

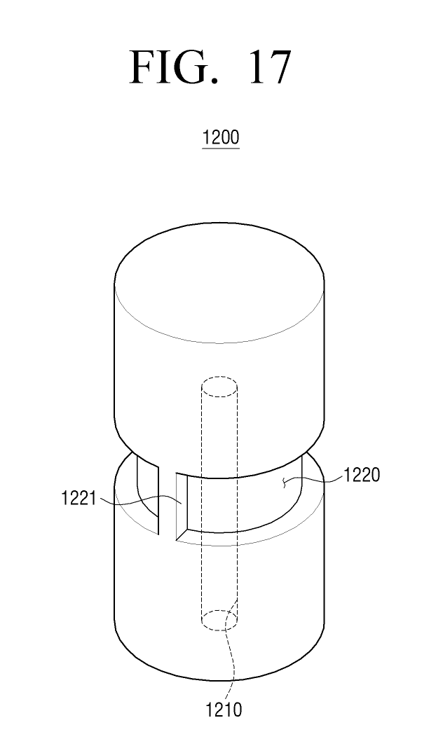

FIG. 17 is a perspective view of a second modified example of a screw accommodation member. A screw accommodation member 1200 according to the second modified example may be shaped like a cylinder and may include a screw coupling groove 1210 that is formed through the screw accommodation member 1200 toward an upper end from a lower end in a longitudinal direction. In addition, the screw accommodation member 1200 may further include a separation prevention groove 1220 that is formed on a lateral surface of the screw accommodation member 1200 toward an internal side of the screw accommodation member 1200. The separation prevention groove 1220 may be formed along a circumference of the screw accommodation member 1200. The separation prevention groove 1220 may further include a plurality of rotation prevention wings 1221 that protrude to an external side of the screw accommodation member 1200. Accordingly, when the screw accommodation member 1200 is insert-molded into the inner case 10, the protrusion 11 may be formed to correspond to shapes of the separation prevention groove 1220 and the rotation prevention wing 1221. Thus the separation prevention groove 1220 and the rotation prevention wing 1221 may interfere with the corresponding protrusion 11. Thereby, the screw accommodation member 1200 may be prevented from being separated or rotated inside the protrusion 11.

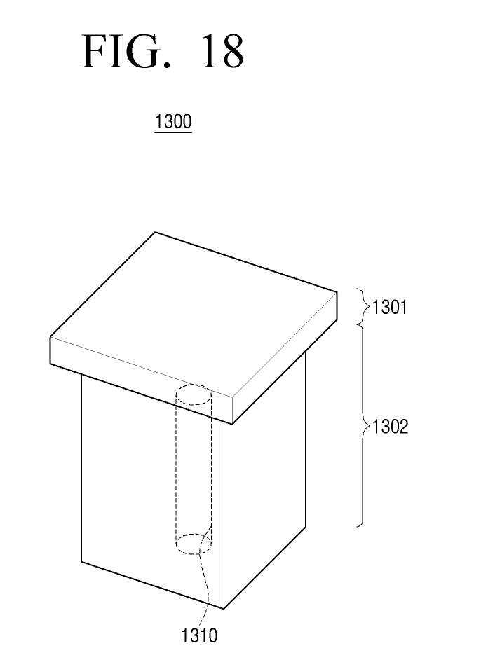

FIG. 18 is a perspective view of a third modified example of a screw accommodation member. A screw accommodation member 1300 according to the third modified example may be shaped like a rectangular parallelepiped shape and may include a screw coupling groove 1310 that is formed through the screw accommodation member 1300 toward an upper end from a lower end in a longitudinal direction. The screw accommodation member 1300 may have an angulated shape and, thus, interfere with the protrusion 11. Accordingly, the screw accommodation member 1300 may be prevented from being rotated in the protrusion 11. A head portion 1301 of the screw accommodation member 1300 may be formed with a greater width than that of a body portion 1302 and formed with a step difference with the body portion 1302. Accordingly, a portion of the head portion 1301, corresponding to the step difference, may interfere with the protrusion 11, thereby preventing the screw accommodation member 1300 from being separated in the protrusion 11.

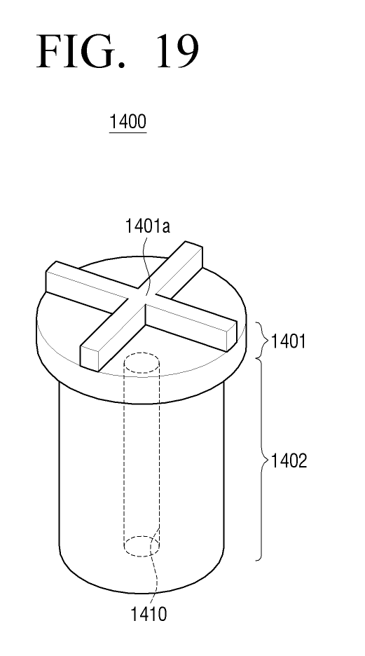

FIG. 19 is a perspective view of a fourth modified example of a screw accommodation member. A screw accommodation member 1400 according to the fourth modified example may be shaped like a cylinder and may include a screw coupling groove 1410 that is formed through the screw accommodation member 1400 toward an upper end from a lower end in a longitudinal direction. A head portion 1401 of the screw accommodation member 1400 may be formed with a greater width than that of a body portion 1402 and may be formed with a step difference with the body portion 1402. Accordingly, due to the step difference of the head portion 1401, the screw accommodation member 1400 may be prevented from being separated in the protrusion 11.

The head portion 1401 may further include a plurality of rotation preventers 1401a that protrude outward. The rotation preventer 1401a may be shaped like a cross that protrude toward an upper side of the head portion 1401. Accordingly, the protrusion 11 is formed to correspond to shapes of the head portion 1401 and the rotation preventer 1401aand, thus, the rotation preventer 1401a may interfere with the protrusion 11 so as to prevent the screw accommodation member 1400 from being rotated. The rotation preventer 1401a may be formed with any shape such as a straight line or a curved line as long as the screw accommodation member 1400 is prevented from being rotated.

With regard to the aforementioned inner case for a refrigerator and a method of manufacturing the same, during molding of the inner case, a screw fixation member may be insert-molded into an inner case sheet. Accordingly, a procedure of separately coupling the screw fixation member to the inner case to fix an internal component to the inner case may be omitted and an inferiority rate of a procedure of coupling the screw fixation member to the inner case may be reduced. Thereby, the inner case for a refrigerator and a refrigerator including the inner case may be manufactured with reduced manufacturing time and cost and may also have enhanced quality.

Although only the screw accommodation member is insert-molded into the inner case for a refrigerator according to the present disclosure, other small components other than the screw accommodation member may be insert-molded directly into the inner case sheet during molding of the inner case for a refrigerator, thereby simplifying a manufacturing procedure of the refrigerator.

The aforementioned method of manufacturing the inner case for a refrigerator may be used to manufacture products such as a TV, an air conditioner, and a washing machine, which are formed by coupling various components to internal and external cases, as well as to the inner case for a refrigerator.

The foregoing exemplary embodiments and advantages are merely exemplary and are not to be construed as limiting the present disclosure. The present teaching can be readily applied to other types of apparatuses. Also, the description of the exemplary embodiments of the present disclosure is intended to be illustrative, and not to limit the scope of the claims, and many alternatives, modifications, and variations will be apparent to those skilled in the art.

What is claimed is:

1. A method of manufacturing an inner case for a refrigerator, the method comprising:
disposing a heated inner case sheet above a mold in a chamber;
disposing at least one of screw accommodation member on an external surface of the mold, facing the inner case sheet;
curving the inner case sheet to be convex toward an opposite side to the mold;
moving the mold toward an internal side of the inner case sheet; and
adsorbing the inner case sheet onto the external surface of the mold to form the inner case sheet to correspond to a shape of the mold and insert-molding the screw accommodation member into the inner case sheet.

2. The method as claimed in claim 1, further comprising, after the adsorbing, separating the mold from the inner case sheet.

3. The method as claimed in claim 1, wherein the curving comprises curving the inner case sheet to be convex upward by a pressure difference between an upper portion and a lower portion of the inner case sheet as air above the inner case sheet inside the chamber is discharged out of the chamber.

4. The method as claimed in claim 1, wherein the adsorbing comprises adsorbing the inner case sheet onto the external surface of the mold by a pressure difference between an upper portion and a lower portion of the inner case sheet as air below the inner case sheet inside the chamber is discharged out of the chamber.

5. The method as claimed in claim 1, wherein the disposing of the at least one of screw accommodation member comprises:
spacing the screw accommodation member apart from a fixation pin at a location in which a screw coupling groove formed in the screw accommodation member corresponds to the fixation pin protruding from the external surface of the mold; and
coupling the screw accommodation member to the fixation pin.

6. The method as claimed in claim 1, wherein the disposing of the at least one of screw accommodation member comprises:
disposing the screw accommodation member below the mold so as to face a screw accommodation member hole formed through the mold;
moving the screw accommodation member through the screw accommodation member hole; and
fixing a location of the screw accommodation member while the screw accommodation member protrudes to an external side of the mold.

7. An inner case for a refrigerator, comprising:
a body with a contained therein; and
a screw accommodation member insert-molded into the body.

8. The inner case as claimed in claim 7, wherein the screw accommodation member is shaped like any one of an inverse circular truncated cone, a cylinder, and a rectangular parallelepiped.

9. The inner case as claimed in claim 8, wherein the screw accommodation member comprises a screw coupling groove formed therein in a longitudinal direction of the screw accommodation member.

10. The inner case as claimed in claim 9, wherein a portion of an outer circumferential surface of one end of the screw accommodation member is partially cut to form a rotation prevention surface.

11. The inner case as claimed in claim 9, further comprising a rotation prevention groove formed on an outer circumferential surface of the screw accommodation member toward an internal side of the screw accommodation member.

12. The inner case as claimed in claim 11, wherein the rotation prevention groove is formed at one end of the screw accommodation member in a longitudinal direction of the screw accommodation member.

13. The inner case as claimed in claim 9, further comprising a separation prevention groove formed on an outer circumferential surface of the screw accommodation member toward an internal side of the screw accommodation member,
wherein the separation prevention groove is formed along a circumference of the screw accommodation member.

14. The inner case as claimed in claim 13, wherein the separation prevention groove comprises a plurality of rotation prevention wings protruding toward an external side of the screw accommodation member.

15. The inner case as claimed in claim 9, wherein:
the screw accommodation member comprises a head portion and a body portion comprising the screw coupling groove; and
a width of the head portion is greater than a width of the body portion and is formed with a step difference with the body portion.

16. The inner case as claimed in claim 15, wherein the head portion comprises a plurality of rotation preventers protruding outward.
